(19) United States
(12) Patent Application Publication
(10) Pub. No.: US 2014/0372137 A1
(43) Pub. Date: Dec. 18, 2014

(54) MEDICAL DISPOSITION SYSTEM AND METHOD FOR GENERATING DISPOSITION ANALYSIS

(71) Applicant: Dynamic Health Inventions, LLC, Parkville, MO (US)

(72) Inventors: Thomas W. Tryon, Parkville, MO (US); Jason C. Marshall, Parkville, MO (US)

(21) Appl. No.: 14/303,265

(22) Filed: Jun. 12, 2014

Related U.S. Application Data
(60) Provisional application No. 61/833,967, filed on Jun. 12, 2013.

(51) Int. Cl. G06F 19/00

(52) U.S. Cl. CPC G06F 19/3443
USPC 705/2

(57) ABSTRACT

A medical disposition system and related method of determining a medical disposition based upon patient queries which will empower the patient to seek healthcare at the proper location and at the proper time, and prevent unnecessary expense and visits to emergency departments. The present invention does not attempt to diagnose a patient's ailment based upon a database of possible results based upon the localization of the ailment. Instead, the present invention seeks to determine the disposition of the patient and instruct the patient on the appropriate measures to address the ailment. The dialogue exchange occurs at a seventh-grade health literacy level. The software application seeks out additional information from the patient's healthcare provider(s), third party resources, and other sources containing relevant data that may affect the patient's disposition. The software application then returns to the patient a response instructing the patient the proper course of management.

### CROSS-REFERENCE TO RELATED APPLICATIONS

This application claims priority in U.S. Provisional Patent Application No. 61/833,967, filed Jun. 12, 2013, which is incorporated herein by reference.

### BACKGROUND OF THE INVENTION

1. Field of the Invention

The present invention is generally related to a software solution for handling medical inquiries and related data, and more specifically to a third-party software and database platform for answering patient health queries and contacting relevant medical health professionals to seek additional data for responding to queries.

2. Description of the Related Art

Every year, billions of dollars are misspent on healthcare. Patients visit the emergency room of hospitals when they should merely schedule an appointment with their primary care physician. This problem is exacerbated as patients who really do need to visit the emergency department are forced to wait, compounding their injuries. There have been attempts to address patient questions relating to healthcare needs through third-party software applications in an attempt to diagnose or address healthcare issues. However, these diagnostic solutions often do more harm than good.

Existing solutions exist for providing basic health information to patient queries based upon basic symptom information. However, these programs are merely diagnostic instead of being disposition solutions. For example, the most common example would be the software behind WebMD®, a product of WebMD, LLC whose corporate headquarters is 111 8^{th} Ave, 7^{th} Floor, N.Y., N.Y. 10011. This tool is a symptom checker which provides basic diagnostic results based solely upon data provided by the patient. This manner of data collection related to healthcare disposition is inadequate. A readily available software tool which can lead to true and accurate health-related dispositions would reduce healthcare costs and increase the likelihood that a patient receives helpful and accurate information relating to their health concerns.

These existing platforms are also stand-alone diagnostic programs which do little to actually get the patient the care they need. What is needed is an integrated healthcare solution which takes patient queries through computer software programs and provides the patient with a disposition solution, instructing the patient where they need to go to address their healthcare concerns, rather than providing a laundry list of possible ailments and the treatments associated with each. Such a system could be integrated into and offered along with health insurance programs and/or private healthcare provider networks.

Heretofore there has not been available a medical disposition system with the advantages and features of the disclosed subject matter.

### SUMMARY OF THE INVENTION

The present invention features a medical disposition system and related method of determining a medical disposition based upon patient queries. Unlike previous diagnostic tools, the present invention does not attempt to diagnose a patient's ailment based upon a database of possible or even likely results based upon the localization of the ailment. Instead, the present invention seeks to determine the disposition of the patient and instruct the patient on the appropriate measures to address the ailment.

A patient accesses the software application and provides all of the relevant details pertaining to their disposition. The software application seeks out additional information from the patient's healthcare provider(s), third party resources, and other sources containing relevant data that may affect the patient's disposition. The software application then returns to the patient a response instructing the patient on what sort of treatment he or she should pursue, whether that be immediate emergency medical attention, urgent medical attention, to schedule a visit with their primary care physician, or to manage the issue at home with follow-up monitoring by the disposition system.

The present invention is not designed to be a stand-alone option for healthcare answers. Rather, this invention is designed to accompany business elements already in place in the healthcare industry with the intent of reducing healthcare costs by directing patients to the correct healthcare provider to address their issues.

The goal of the present invention is to provide patients with healthcare dispositions to direct the patient to the appropriate course of action, rather than an attempt to provide the patient with a diagnosis based upon the patient's interpretation of lists of data of possible ailments presented to the patient. The information presented to the patient with the present invention would preferably be presented at a seventh-grade health literacy level in English, Spanish, and other languages.

### BRIEF DESCRIPTION OF THE DRAWINGS

The drawings constitute a part of this specification and include exemplary embodiments of the invention illustrating various objects and features thereof, wherein like references are generally numbered alike in the several views.

FIG. 1 is a box diagram illustrating the relationship between various elements of a preferred embodiment of the present invention.

FIG. 2 is a box diagram illustrating the relationship between various elements of a preferred embodiment of the present invention.

FIG. 3 is a flowchart demonstrating the steps of practicing an element of a preferred embodiment of the present invention.

FIG. 4 is a flowchart demonstrating the steps of practicing an element of a preferred embodiment of the present invention.

FIG. 5 is a flowchart demonstrating the steps of practicing an element of a preferred embodiment of the present invention.

FIG. 6 is a flowchart demonstrating the steps of practicing an element of a preferred embodiment of the present invention.

FIG. 7 is a flowchart demonstrating the steps of resolving an example disposition based upon a patient query.

FIG. 8 is a flowchart demonstrating the steps of resolving a specific disposition for a patient having a fever.

FIG. 9A is a screenshot of a user interface associated with the practice of a preferred embodiment of the present invention, showing the selection of the location of an ailment or symptom using a user interface.

FIG. 9B is a screenshot of a user interface associated with the practice of a preferred embodiment of the present invention, showing the selection of a symptom of an ailment using a user interface.

FIG. 9C is a screenshot of a user interface associated with the practice of a preferred embodiment of the present invention, showing the selection of an audible symptom using a user interface.

FIG. 9D is a screenshot of a user interface associated with the practice of a preferred embodiment of the present invention, showing the selection of a physically visible symptom using a user interface.

FIG. 9E is a screenshot of a user interface associated with the practice of a preferred embodiment of the present invention, showing the textual input of symptom information into a search bar and results from that search.

FIG. 9F is a screenshot of a user interface associated with the practice of a preferred embodiment of the present invention, showing preliminary questions from the software application which corresponds with a resulting disposition.

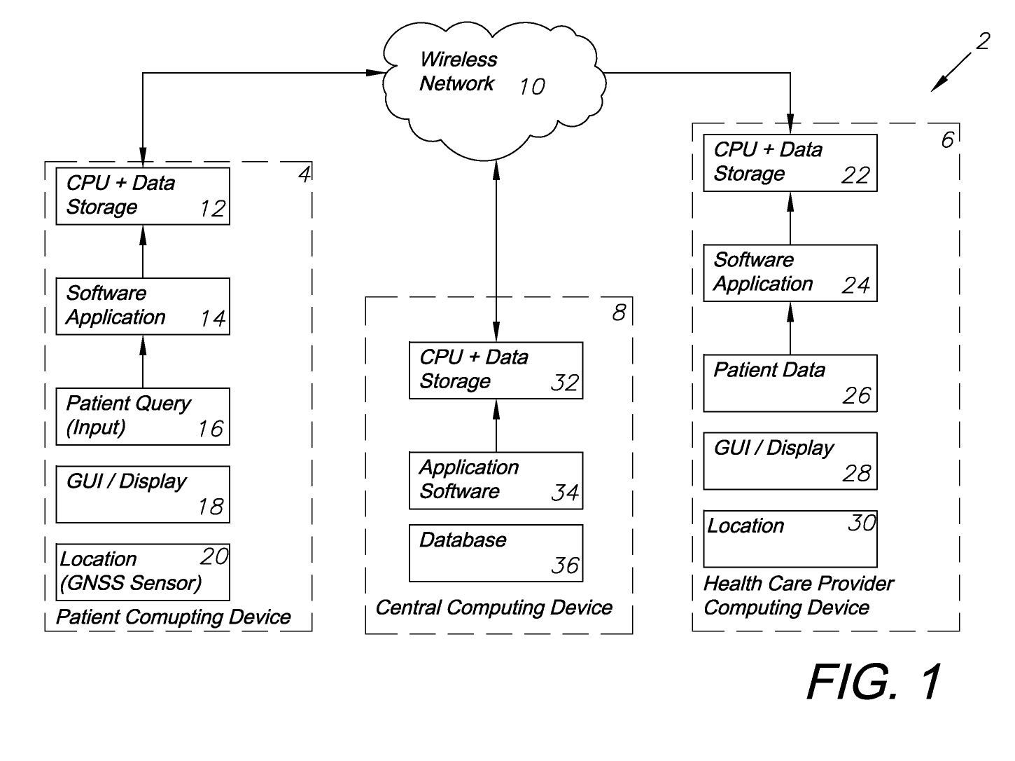

### DETAILED DESCRIPTION OF THE PREFERRED EMBODIMENT

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Additional examples include computing devices such as a mobile smart device including a display device for viewing a typical web browser or user interface will be commonly referred to throughout the following description. The type of device, computer, display, or user interface may vary when practicing an embodiment of the present invention. A computing device could be represented by a desktop personal computer, a laptop computer, “smart” mobile phones, PDAs, tablets, or other handheld computing devices. Healthcare providers may include any person or entity within the healthcare field, from insurance providers, to pharmacists, to hospitals, to doctors, and more. Said terminology will include the words specifically mentioned, derivatives thereof and words of similar meaning.

### II. Medical Disposition System 2

Referring to the drawings in more detail, the reference numeral 2 generally designates a preferred embodiment medical disposition system 2 which generally includes a patient having a patient computing device 4, a health care provider having a health care provider computing device 6, and a centralized server computing device 8, all connected via a wireless network 10, such as the internet.

The Patient computing device 4 typically includes a CPU and data store 12 which stores and runs a software application 14. The patient computing device 4 also includes a user interface display 18. A preferred embodiment would also include a location sensor 20, such as a global navigation satellite system (GNSS) sensor capable of determining the precise location of the patient computing device 4. Optionally the position could be entered by a user. The patient enters a patient query input 16 into the software application 14 which is processed by the CPU and is sent through the wireless network 10.

A health care provider computing device 6 likewise includes a CPU and data storage 22 element, a separate software application 24 stored and run by the CPU and data storage elements, and stored patient data 26 logs. These patient data logs include previous patient data, such as medication being taken, past medical history, and other information known to the provider. The health care provider's computing device 6 would also include a user interface display 28 for interacting with the software and a known location 30 of that healthcare provider. The health care provider's computing device 6 receives patient queries 16 sent from the patient computing device 4 along with data from the central computing device 8.

The central computing device 8 includes a CPU and storage element 32 along with the core application software 34. This software may be updated here prior to updates being applied to the software applications 14, 24 of the patient computing device 4 and the health care provider computing device 6. A database 36 is stored on the central computing device 8 containing all relevant and known factors which may affect how data is transferred between the patient computing device 4, the central computing device 8, and the health care provider computing device 6. The database will also contain third-party data.

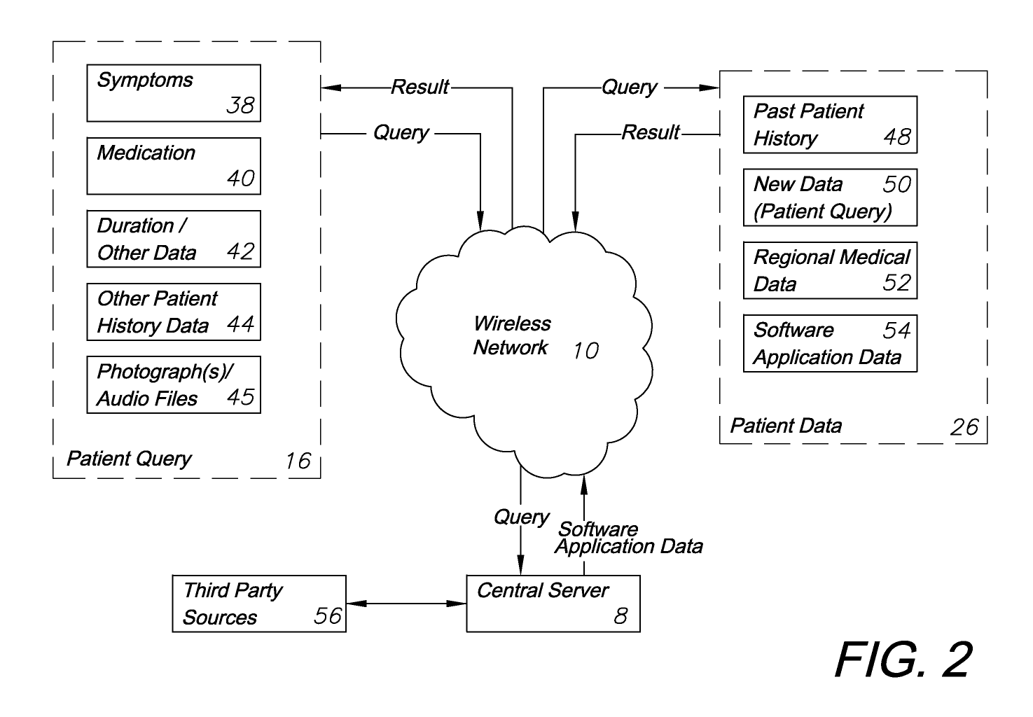

FIG. 2 shows the relationship between the patient query 16 and patient data 26 as it is transferred through the wireless network 10 between the various parties. As diagrammed, a patient query 16 typically includes at least one symptom 38 and other related medical information such as the medication 40 currently being taken by the patient, the duration 42 of the symptoms, or other symptom-related data. Other patient history data 44 in the patient's possession may also be uploaded through the patient query. Photographs and audio files 45 along with other multimedia evidence of symptoms may also be uploaded with the patient query.

All of this data is sent through the wireless network 10 to the centralized sever 8. The central server has access to third party sources 56, including health care providers, insurance providers, and other information databases. The central server will attempt to provide the patient's query with a disposition result based upon the data received in the patient query along with data obtained from third parties, including health care professionals. The application software 34, along with the CPU 32, calculates what should be the response to the patient. If needed, the patient query is forwarded on to healthcare providers, such as the patient's primary care physician, to supplement the disposition result. The healthcare provider has additional patient data 26 such as past patient history 48, new patient data 50 based upon the patient query 16, regional medical data 52, such as recent outbreaks of disease in the area, along with related software application data 54 which may have been customized by the health care provider. The healthcare provider will look at the patient query and all additional information and analyze it with the health care provider computing device 6 to reach a disposition result. This result is sent back through the network to the patient, who is instructed how to proceed.

All new data is stored in the central server 8 database 36 and is used for future disposition calculations, as well as by third party entities for unrelated purposes. These purposes may include: increasing the knowledge base around certain diseases and ailments; increasing information about certain genetic diseases; increasing the health care provider network's knowledge about symptoms relating to diseases and other dispositions; and notifying insurance agencies about claims in the area. The data may also be sent through an analytic algorithm to determine the cost savings of having a patient use this semi-automated disposition system to receive the correct disposition and healthcare instructions rather than had that patient gone straight to the emergency room or, even worse, ignored the ailment until it became worse and more costly.

The present invention generally relies upon a generated decision tree which branches depending on what information is known to the disposition system 2, what information is entered into the system by the patient via the patient query 16, and other data that may be provided by health care providers or other third-parties during the disposition review. This decision tree concept is generally outlined through several flowcharts described below.

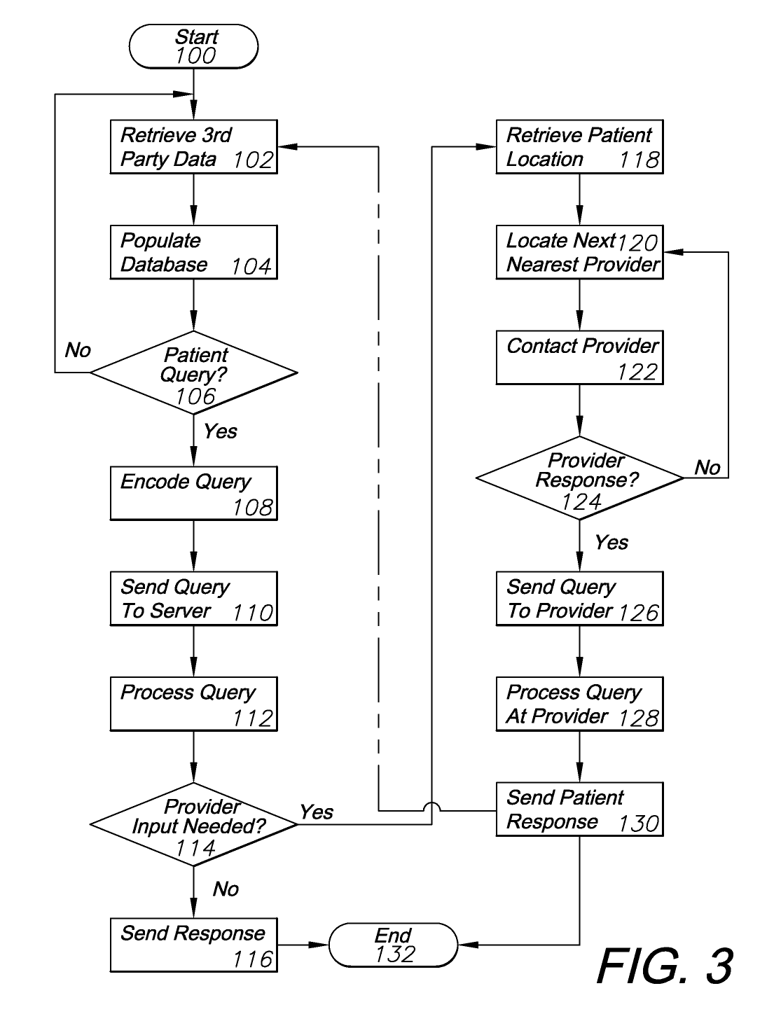

FIG. 3 is a flowchart diagramming the steps generally taken when a patient query is input into the system and a disposition result is sought. The method starts at 100, and third party data is retrieved by the central server at 102. The database 36 for disposition analysis is populated at 104. This essentially sets up the software application 14, 24 and the application software 34 to communicate and for the processor 32 to be able to sort through the database of symptoms, knowledge, and other data and response to a patient query 16.

If a patient query is entered at 106 then the query is encoded 108 for use within the central database to be interpreted through the application software. Otherwise the database continues to retrieve inputs from external third parties at 102 and populate the database at 104.

The encoded query is sent to the server at 110 where it is processed at 112 by the central server's CPU. Once the query is processed, the CPU will make a determination of whether health care provider input (e.g. a doctor) is needed at 114. If not, the server sends back a response at 116 which is determined by the server CPU and provided through the patient's software application. The process ends at this step at 132. The response to the patient may include instructions to see a health care provider or to go to the emergency room.

If provider input is needed at 114, the patient's location is determined at 118 and the nearest health care provider is located at 120. There may be parameters limiting which providers can be listed, such as those providers who are in network with the patient's health insurance provider, or those providers who the patient has indicated are their primary care physicians. The nearest provider is contacted at 122 and a check is performed to see if the provider is capable of responding at that time at 124. If not, the next provider on the list is located at 120 and process repeats.

If the provider responds at 124, the patient query is sent to the provider at 126 through the central server. The provider processes the query at 128 through its computer system using its database of patient history and other data to evaluate the patient query. A patient response is sent to the patient from the provider at 130. This response could go directly from the provider to the patient, or it could be filtered through the software application located at the central server. Data based upon the provider's response at 130 is also sent to the central server via the dashed line shown in FIG. 3, which represents only data flow and not a step in the method.

This data is seen as third party data and populates into the database to increase the ability of the software application at the central server, via the central server CPU, to respond to similar patient queries in the future.

It should be noted that the response to the patient from either the software application or the health care provider should take the form of a patient disposition, directing the patient to the appropriate place to obtain health care, rather than to attempt to produce a diagnosis of the patient's ailment based upon the patient's inputs alone.

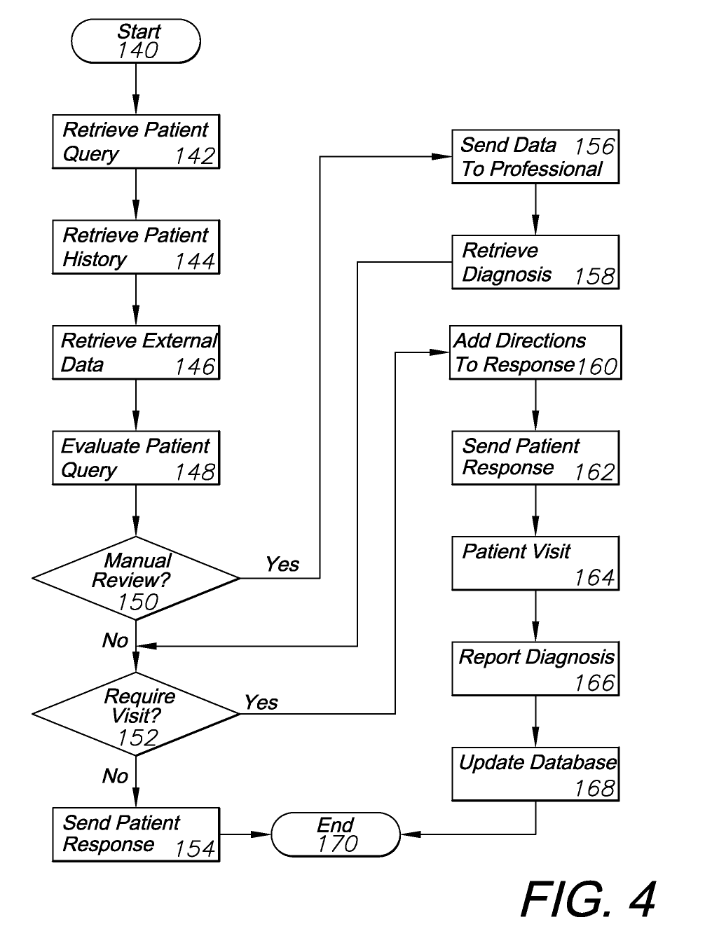

FIG. 4 is a flowchart diagraming the steps taken when the health care provider provides a response to a patient query. The process starts at 140 and the health care provider retrieves the patient query at 142. The provider then retrieves all patient history records at 144, and all relevant external data at 146. The patient query is then evaluated at 148 while all of these data factors are taken into account. This process is likely performed by the health care provider computing device 6 CPU 22. Alternatively, this could be performed at the central server 8 using data stored at the health care provider.

A determination is made at 150 whether manual review of the patient query and related data is needed. If no, then a second determination is made whether the determination requires a patient visit at 152. If no, then a disposition response is formulated and sent to the patent at 154 and the process ends at 170.

If manual review is necessary at 150, then the data is sent to a professional to review at 156. After the review, a diagnosis is retrieved at 158 based upon the professional review, and the determination of whether a visit is required occurs at 152. Again, if no, a patient disposition response is determined and sent to the patient at 154 and the process ends at 170.

If a visit is determined necessary at 152, direction to the medical care provider are added to the disposition response at 160, and the response is sent to the patient at 162. The process then is on stand-by until the patient visit occurs at 164. The professionals will examine the patient in the ordinary course, and then the results of that examination will be given to the patient and will also be uploaded through the software application to the central server at 166. The database(s) are updated at 168 and the process ends at 170.

It should be noted here that the requirements for having the patient diagnoses reached by the professional entered into the disposition system 2 allows the disposition system to essentially become “smarter.” Future patient queries with similar symptom features may not require an in-face doctor visit based upon the outcome of previous visits.

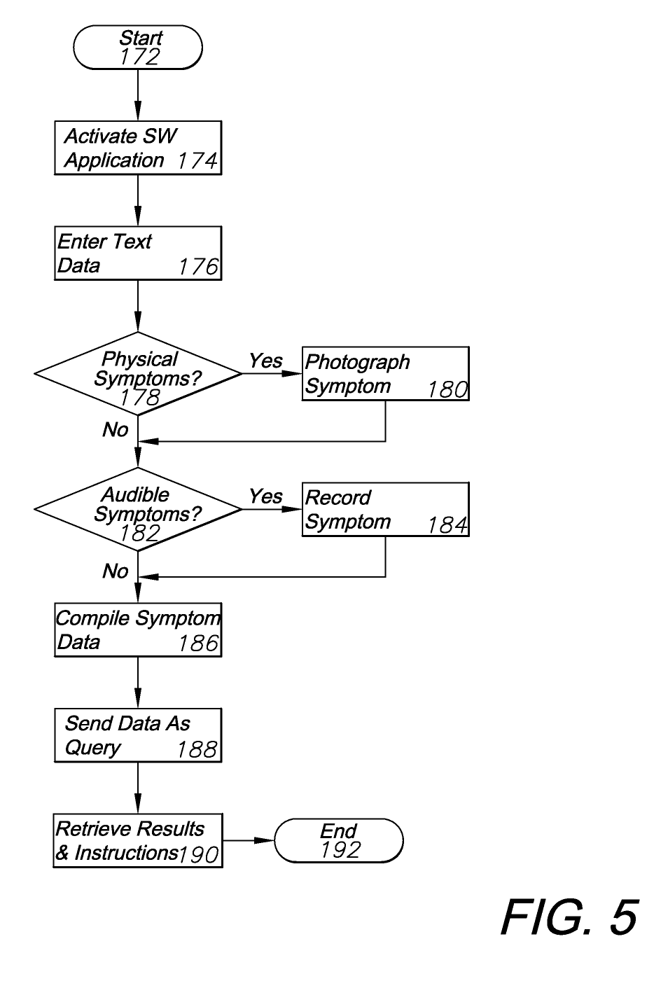

FIG. 5 is a flowchart demonstrating the steps taken for submitting a patient query 16 through a patient computing device 4. The process starts at 172 and the software application is activated at 174. The patient interacts with the software application through user interface, such as a touch screen, mouse and keyboard, or other standard computer user interface. The patient first enters text data at 176 which describes the symptoms the patient is suffering from and generally describes the area of the body being affected. The patient is asked whether there are physical symptoms at 178. If yes, the patient takes a photograph of those symptoms (e.g. rash, swelling) at 180. The patient is then asked whether there are audible symptoms (e.g. cough) at 182. If yes, the patient takes an audio recording of the symptom at 184. All of this symptom data is compiled and uploaded as the patient query at 186. The query is sent at 188. Results are eventually returned to the patient at 190 in the form of a disposition, instructing the patient who to call or what to expect based upon the symptoms as presented by the patient. If the instructions require the patient to visit a health care provider, directions may be returned along with the result. This process ends at 192.

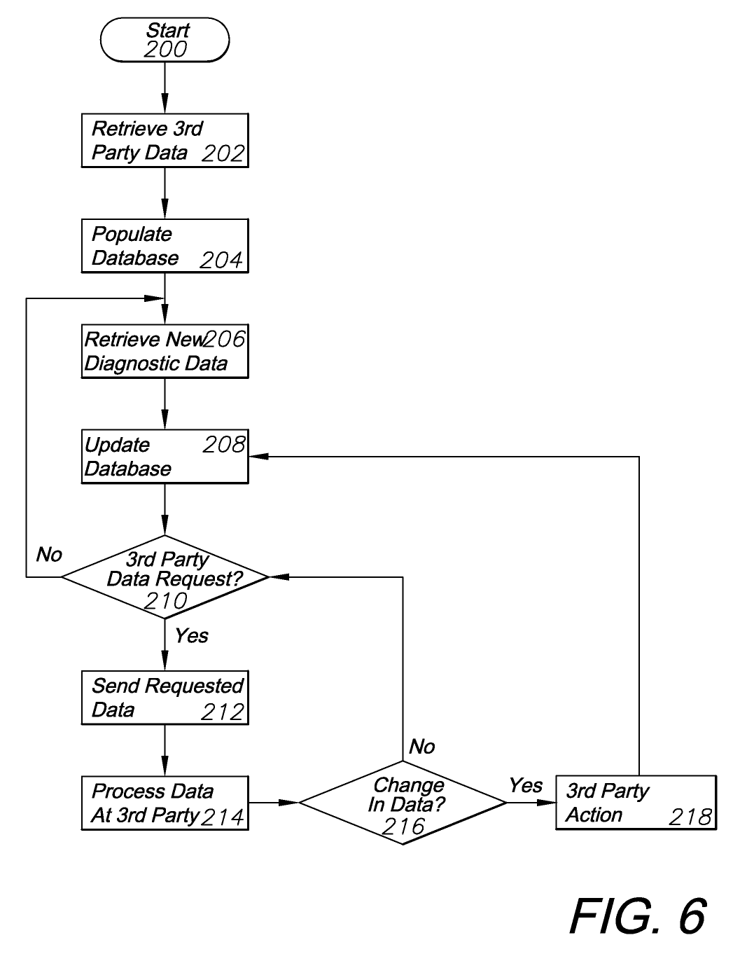

FIG. 6 is a flow chart demonstrating how third party data and third party diagnostics are incorporated into the practice of a method of the present invention. The process starts at 200 and third party data is received at the central server at 202. This data may be delivered directly from the third party as part of a relationship between the third party and the disposition system 2, or it may be based upon research performed in conjunction with the disposition system 2, or it may be some other public source of information, or, as described above, it may come directly from health care providers based upon prior patient queries.

The database is populated with third party at 204. New diagnostic data is received at 206. This data may come from any of the sources above, and adds to the database of knowledge available to the disposition system 2. The database is updated at 208 as this new diagnostic data is received.

Third parties may make requests of data from the disposition system. If such a request is not made at 210, the database continues to be updated as new diagnostic data is received at 206. Once a third party request is made at 210, the requested data is sent to the third party at 212. Here, third parties may be health care providers, insurance companies, or even statisticians using the data to help increase responsiveness and effectiveness of health care providers.

The data is processed at the third party location at 214, such as at a doctor's office. If a change in data, or some other meaningful result is determined based upon the data, at 216, the third party may take some action at 218. This action may be a doctor's disposition result for a patient, or it may be the recognition of an outbreak in the area of a particular disease, or it may even be a breakthrough in some genetic testing based upon data stored in the disposition system database. This updated data is sent back into the database which is updated at 208.

If no change in data as described above is determined at 216, then the procedure returns to ask if there is another third party request. The cycle continues as new data is absorbed and new requests are performed.

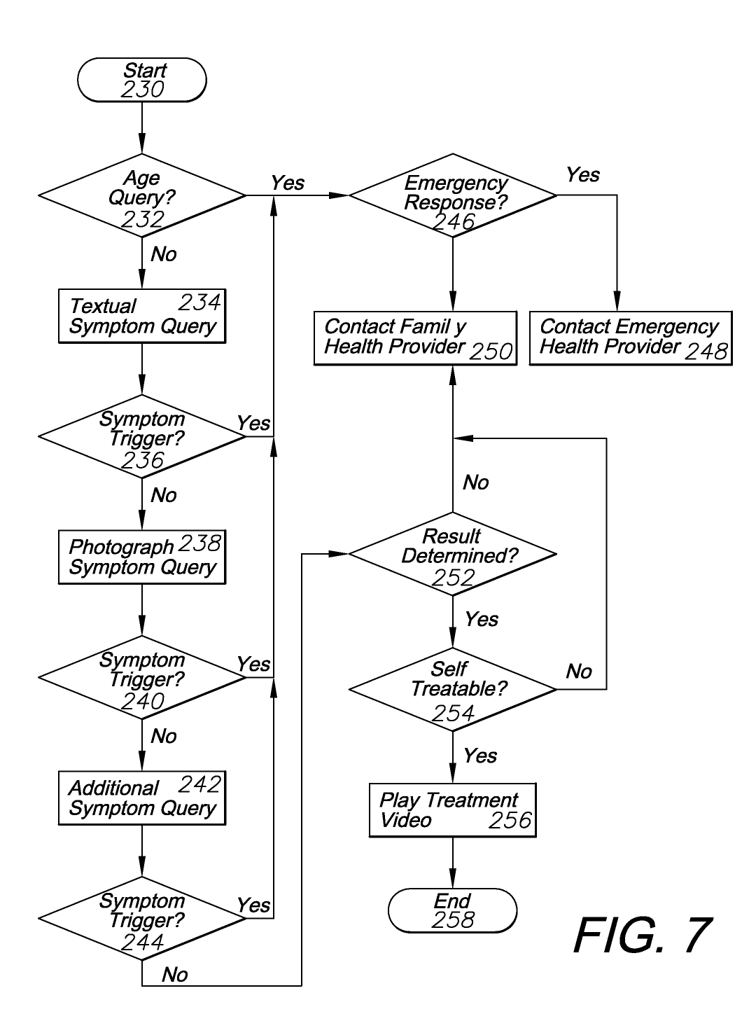

FIG. 7 presents the steps of practicing an embodiment of the present invention for performing a generic example of a patient query having symptoms. The process starts at 230 and may begin with an age query at 232. The query may ask whether the patient is less than 2 months old, over sixty years old, or some other quantifier. Depending on the response at 232, the disposition system 2 will require a determination immediately at 246 whether emergency procedures are necessary. For example, if a two-month old patient has a fever over 104°, the disposition system will tell the patient or the user to immediately contact an emergency health provider at 248. Otherwise it will recommend contacting the patient's pediatrician or other family health provider at 250.

If the age query returns a range that does not require immediate attention, the patient will be asked to enter textual symptom information into the query at 234. This may include the location of the body where pain is occurring or the description of other symptoms (e.g. sneezing, wheezing, and shortness of breath). If these symptoms trigger a disposition result at 236 within the disposition system 2, then a determination of whether or not there is an emergency response need is made at 246. If yes, the patient is instructed to immediately contact an emergency health provider at 248; otherwise, the patient is instructed to contact their primary care provider at 250.

If the textual symptoms do not trigger a disposition result, the patient may then be asked to submit photographs of physical symptoms, if any, the patient is suffering from at 238. Again, if these symptoms trigger a disposition result at 240 within the disposition system 2, then a determination of whether or not there is an emergency response need is made at 246. If yes, the patient is instructed to immediately contact an emergency health provider at 248; otherwise, the patient is instructed to contact their primary care provider at 250.

If the physical symptoms do not trigger a disposition result, other additional symptom queries may be entered at 242. These may include additional textual symptoms, or choices from a list produced by the disposition system 2, or audio files for audible symptoms. Again, if these symptoms trigger a disposition result at 244 within the disposition system 2, then a determination of whether or not there is an emergency response need is made at 246. If yes, the patient is instructed to immediately contact an emergency health provider at 248; otherwise, the patient is instructed to contact their primary care provider at 250.

If no trigger is determined, the system checks to determine whether it is capable of producing an automated result for the patient at 252. If not, it suggests following up with the patient's primary care provider. If there is a result, the system determines whether the condition is self-treatable at 254 based upon the determined disposition. If not, it suggests following up with the patient's primary care provider. If the ailment is determined to be self-treatable, the system sends a result at 256 which may include a video indicating how to treat the symptom(s) of the ailment. For example, if it is determined that the user has a mild eye irritation, the video may show how to put eye drops into your eye to flush out the irritant or otherwise sooth the irritation. The process then ends at 258. Not shown in the chart, but possible in an optimized embodiment of the present invention, is a scheduling step. The patient computing device 4 would schedule the self-treatment procedure required by the video, and would request from the patient follow-up data after the self-treatment should have occurred according to the schedule. This follow-up data may then lead to a different diagnosis.

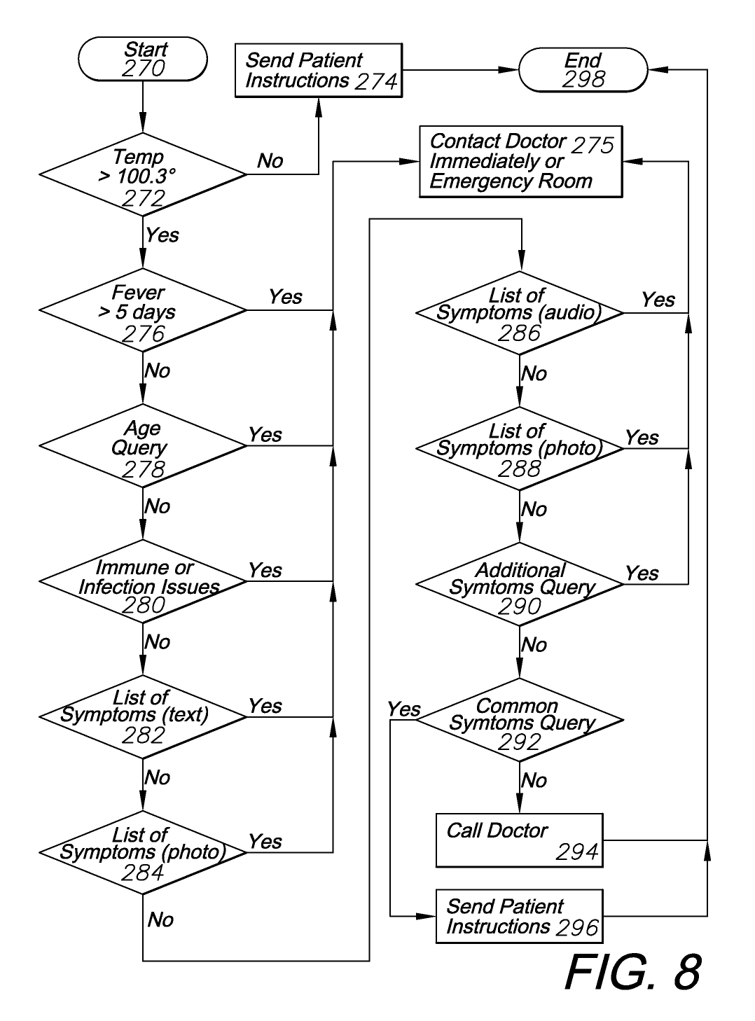

FIG. 8 goes one step further and provides a specific example of how a patient suffering from a fever would use a preferred embodiment disposition system 2. The process starts at 270 and the first question posed by the disposition system software would be whether the patient's temperature exceeds 100.3° Fahrenheit at 272. If not, instructions are sent to the patient at 274 which basically indicate that fevers at or below 100.3° Fahrenheit are not indicative of a need for immediate medical attention. The instructions may suggest taking aspirin or another fever reducer and to continue checking the patient's temperature at a regular basis. The process would then end at 298.

If the patient answers that their fever is above 100.3° Fahrenheit at 272, the next question may be whether the fever has been present for more than five days at 276. Alternatively, the question presented to the patient would simply ask how long the fever has been persisting. If the fever has been present for more than five days at 276, the system will inform the patient to either contact their doctor immediately or to head to the nearest emergency room at 275. Instructions to the location of choice may also be provided by the disposition system. The process then ends at 298.

If the fever has not been present for more than five days at 276, the next question presented by the disposition system may be the age of the patient at 278. Similar to the discussion above, if the age of the patient falls within a pre-determined threshold of ages (e.g. under two months or over sixty years), the patient may be instructed to either contact their doctor immediately or to head to the nearest emergency room at 275. Instructions to the location of choice may also be provided by the disposition system. The process then ends at 298.

If the patient does not fall within a specific age threshold at 278, the patient may be asked whether the suffer from any immune or infection issues at 280, or any other key factors which may require immediate medical attention. If the patient does indeed suffer from any of these factors, the patient may be instructed to either contact their doctor immediately or to head to the nearest emergency room at 275. Instructions to the location of choice may also be provided by the disposition system. The process then ends at 298.

If the patient does not suffer from additional immunity or infection issues at 280, they may next be asked to list their symptoms or choose from some predetermined text-based symptom queries at 282. If any of these symptoms cause the disposition system to trigger an alert at 282, the patient may be instructed to either contact their doctor immediately or to head to the nearest emergency room at 275. Instructions to the location of choice may also be provided by the disposition system. The process then ends at 298.

Similarly, the patient may be asked to provide photographs of their visible symptoms at 284, if any. Like above, if any of these symptoms cause the disposition system to trigger an alert at 282, the patient may be instructed to either contact their doctor immediately or to head to the nearest emergency room at 275. Instructions to the location of choice may also be provided by the disposition system. The process then ends at 298.

A similar process will take place regarding audio symptoms at 286, if any. Again, the results may trigger a response instructing the patient to contact their doctor or the local emergency room at 275.

A follow-up query may be presented by the system at 288 where a number of photographs are presented to the patient. The patient may select any photographs which match their physically visible symptoms. The results could trigger the need to seek immediate medical attention.

If no trigger has been reached, the patient may be asked to enter additional information about their symptoms at 290. An optional step not shown in FIG. 8 would send these results to a medical professional who may examine them and determine whether or not immediate medical attention is necessary. These other symptoms may also be reviewed by the disposition system 2 and may automatically trigger such a response.

If no trigger for immediate medical attention has occurred, the disposition system may ask the patient whether they are suffering from common symptoms at 292. In the case of a fever, the query may ask about sneezing, coughing, or other symptoms indicating that the patient is suffering from the common cold. If the patient indicates this is correct, the disposition system 2 will send the patient common instructions on how to treat the symptoms of the common cold at 296, and the process ends at 298. Note that this result will only generate such a diagnosis when all other probable results have been eliminated.

If the patient indicates that they are not suffering from the common symptoms listed by the disposition system at 292, but no trigger for immediate medical attention has occurred previously, the patient will be instructed to set up an appointment with their primary care physician at 294 and the process ends at 298.

It should be understood that this is just one example of one ailment and how the disposition system 2 of a preferred embodiment invention would respond to the patient query. Different ailments and symptoms may trigger different responses from the disposition system. As the disposition system evolves over time, what may trigger an emergency alert may change. Other symptoms or patient data not listed in these steps may also be gathered by the disposition system 2 from the patient or third parties when evaluating a patient disposition.

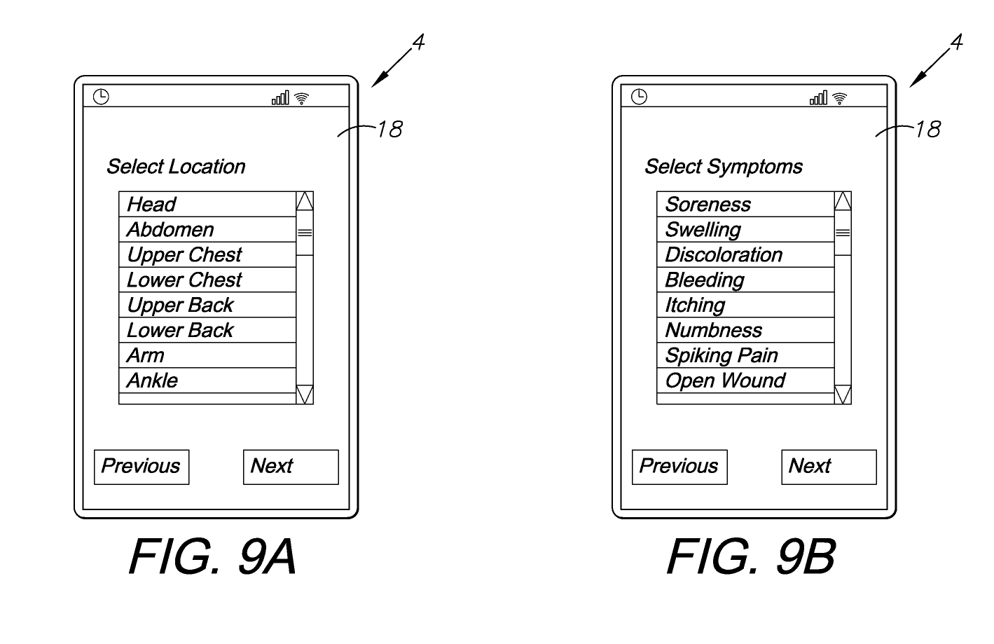

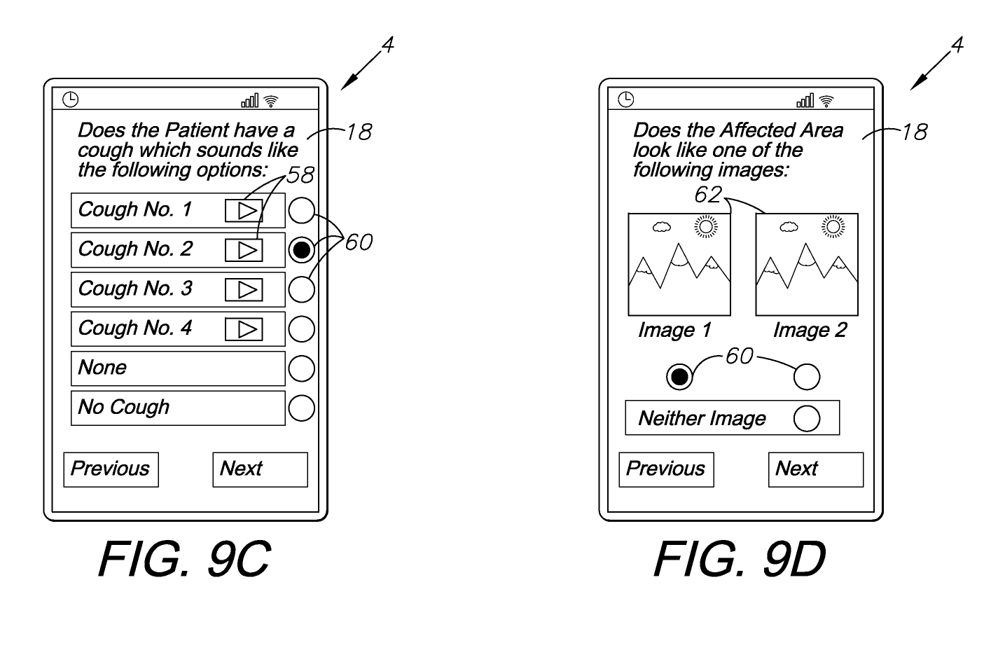

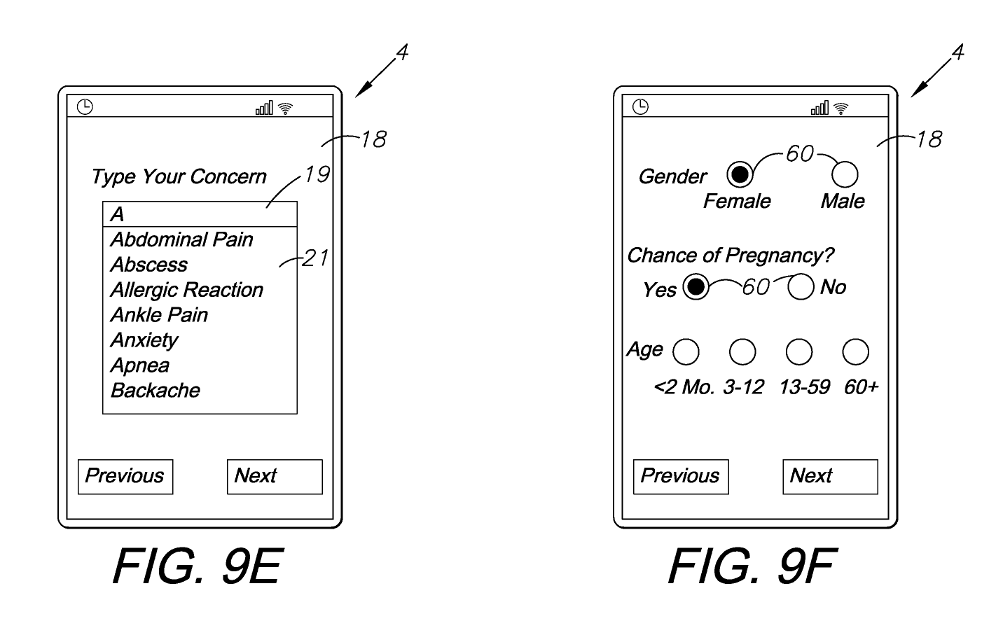

FIGS. 9A-F show an example of a screenshot of a user interface 18 as it may appear on a mobile computing device 4 used by a patient when accessing the software application 14. FIG. 9A in particular shows the selection of the location on the patient's body where the pain, discomfort, injury, or other symptom(s) are occurring. The patient can choose from a list as shown, or alternatively an interactive figure resembling the human body may appear and the patient can select the portion of the body that is affected.

FIG. 9B similarly shows how a patient may select one or more symptoms from a predetermined list. This list is narrowed down by the selection of body location. It may further be narrowed down based upon other information provided by the patient and/or third parties. Alternatively the patient will type the symptoms into the user interface directly.

FIG. 9C shows an example of a user interface where a number of audio files of different types of coughs may be reviewed by the patient by clicking on a “play” icon 58. Once the user has heard all of the cues, they patient will select a selectable radio button 60 relating to their symptom. Options are available if the patient has “no cough” or if none of the sound bites sound like the patient's cough. If “none” is selected, other options may be pulled up in a second screen.

FIG. 9D similarly shows an example of a user interface where the patient is asked to select between two images 62 which may resemble the physically visible symptoms they are suffering from. Again, the patient will select either image or “neither image” by selecting a selectable radio button 60 or otherwise selecting the object. Alternatively the patient will take a photograph of their symptom, upload it, and view it on the user interface 18 to verify the picture is clear.

FIG. 9E shows a user interface 18 including a text bar 19 for typing in a patient's symptoms, and a results list 21 based upon what the patient has typed in. It should be noted that all results will appear at a seventh-grade health literacy level, instead of presenting large medical terms and medical conditions that a lay person would not understand.

FIG. 9F shows a user interface 18 asking basic questions that the patient query 16 needs to establish before eliminating possible symptoms and solutions. For instance, if the gender “male” is selected, the question regarding pregnancy would be removed. Age ranges of important medical significance are also asked about up-front.

Other features relating to the various elements described throughout may be incorporated into the user interface to varying degrees. Any typical means of selecting items within a user interface may be used in conjunction or separate of any of the elements mentioned herein.

The major feature of the present invention over the existing prior art is the ability to generate a patient disposition based upon data from parties other than the patient and instruct the patient correctly, in a manner which can be understood by nearly any patient (e.g. at a seventh-grade health literacy level). The patient is instructed to seek the correct guidance to resolve their medical issue, rather than being provided a laundry list of difficult to pronounce diagnoses which the patient must select between based upon similar sounding symptoms of which they have no way to differentiate. Instead of worrying a patient or providing incorrect diagnoses, the present invention makes sure the patient has the best course of action for treating whatever ailment they have based upon data from all sources available, not just what the patient inputs.

Because the present invention can be incorporated into business models within the healthcare industry, such as insurance companies and hospitals, it is important for the software and hardware to be capable of generating reports based upon the results of the disposition system illustrated above. These data analytics will be important to the business side of the healthcare industry, and may drive the way the software application responds to patient queries to increase cost savings to both the providers and the patients.

For example, the system 2 will record how many patients use the application software on a daily basis. Based upon the disposition outcomes, the system 2 can generate data associated with the efficiency of preventing or averting visits to emergency departments or to urgent care that would have likely been burdened with such a visit absent the presence of the disposition system 2. Similar results would be available for averted urgent care or physician office visits that may not have been postponed had the patient been incorrectly alerted to a diagnosis that they were not actually suffering from. The system 2 will record the top presenting complaints entered into patient queries and can generate reports based upon dispositions stemming from those complaints. All of this can lead to a reigning-in of healthcare costs.

### III. Alternative Embodiment Disposition Systems

The present invention could be more specifically applied to systems and methods of producing a disposition. One example would be a pregnancy tracking and advising application which records up to date information provided by the patient to predetermine what could be wrong with the patient or the unborn child during various periods of pregnancy. As data is collected and stored, the disposition system would be able to more accurately determine what may be wrong with the patient and to properly instruct the patient whether the problem can wait until the next meeting with the patient's primary care or OBGYN, or whether immediate emergency medical treatment should be sought.

Similarly, the disposition system could be used for patients with diagnosed or presumed mental health issues. The system could be setup after a traumatic event or after diagnosis of mental illness by a health care provider. The system could track the patient's mood via periodic queries, and ensure that the patient is reminded to take their medication. If the patient fails to check in regularly, the system could automatically alert a guardian or medical personnel to check on the patient immediately.

The same disposition tools could apply to surgical applications as well as typical non-surgical medical issues. For example, a patient who is scheduled for a surgical procedure could access the software application associated with an embodiment of the present invention and could enter information about their diagnosis and the proposed procedure. Through the disposition system described herein, the patient could be instructed to seek a second opinion or be presented with questions that the patient should ask the surgeon prior to consenting to surgery. Additionally, the disposition system could present alternatives to surgery. These suggestions could be beneficial to patients who otherwise may be nervous to second-guess their surgeon.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. A computer implemented method of generating a patient disposition, the method comprising the steps:
registering a patient with a disposition system, wherein said disposition system comprises a central server including a CPU, data storage containing a central database, and connection to a computer network;
populating said central database with external third-party data including at least regional health statistics;
sending a patient query from a first computing device, wherein said first computing device comprises a CPU, data storage, a graphical user interface (GUI), and connection to said computer network, and wherein said patient query comprises at least one symptom;
receiving said patient query at said disposition system;
processing said patient query with said central server's CPU;
generating a disposition at said central server's CPU, said disposition comprising at least one patient instruction written at a seventh-grade health literacy level, and said disposition not including a diagnosis; and
sending said disposition to said patient, and sending a transcript of said disposition to a third-party healthcare entity.

2. The method according to claim 1, further comprising the steps:
receiving third-party medical data at said central server from said third-party healthcare entity;
incorporating said third party medical data into said central database; and
updating said disposition based upon said third party medical data.

3. The method according to claim 2, further comprising the steps:
sending said patient query from said central server to a second computing device, wherein said second computing device comprises a CPU, data storage, a graphical user interface (GUI), and connection to said computer network, and wherein said second computing device is associated with said third-party health care provider;
processing said patient query at said second computing device; and
returning a disposition response to said central server via software application data stored on said data storage of said second computing device.

4. The method according to claim 3, further comprising:
wherein said third party medical data comprises medical data received from a health care provider;
wherein said health care provider is in a healthcare network associated with said patient; and
wherein said third party medical data is selected from one or more of the list comprising:
patient medical history; regional medical data; and processed data resulting from said patient query at said second computing device.

5. The method according to claim 4, further comprising the steps:
determining with said second computing device whether said patient query requires a manual review;
sending said patient query to a medical professional for said manual review;
receiving instructions based upon said manual review; and
updating said disposition.

6. The method according to claim 4, wherein said disposition includes instructions for a patient visit to said health care provider, the method further comprising the steps:
generating a report at said second computing device based upon a patient visit;
sending said report to said database; and
updating said database.

7. The method according to claim 2, further comprising:
wherein said third party medical data comprises medical data received from one or more of: a health insurance provider; a third-party medical database; and a regional hospital.

8. The method according to claim 1, further comprising the steps:
updating said patient query with text indicating at least one symptom; and
further updating said patient query with photographs indicating at least one symptom.

9. The method according to claim 8, further comprising the step:
further updating said patient query with recorded audio indicating at least one symptom.

10. The method according to claim 1, further comprising the steps:
requesting a textual input at said first computing device GUI;
generating a list of symptoms based upon said textual input and presenting said list of symptoms on said first computing device GUI, said list of symptoms being written at a seventh-grade health literacy level; and
updating said disposition based upon a selection of said list of symptoms.

11. The method according to claim 10, further comprising the steps:
presenting at least two images on said first computing device GUI, wherein each of said at least two pictures is associated with a symptom; and
updating said disposition based upon a selection between said at least two images.

12. The method according to claim 10, wherein said first computing device includes an audio speaker, the method further comprising the steps:
presenting at least two audio samples on said first computing device, wherein each of said at least two audio samples is associated with a symptom; and
updating said disposition based upon a selection between said at least two audio samples.

13. The method according to claim 1, wherein said disposition indicates a self-treatable symptom, the method comprising the steps:
associating a video with said disposition;
instructing with said video how said at least one symptom can be self-treated;
scheduling self-treatment with said first computing device; and
requesting follow-up data from said patient with said first computing device after self-treatment is scheduled to have occurred.

14. The method according to claim 1, wherein said at least one instruction comprises one instruction chosen from the list comprising: immediate emergency medical care; urgent medical care; scheduling a visit with a primary care physician; and in-home healthcare management.

15. A system for providing a medical disposition, the system comprising:
a first, second, and third computing device, each having respective a CPU, data storage, graphical user interface (GUI), and connection to a wireless network;
said first computing device including a database stored on said first computing device data storage;
said second computing device associated with a patient having a patient location;
said third computing device associated with a health care provider having a provider location;
a patient query comprising at least one symptom generated by said second computing device and reviewable by said first and third computing devices;
a disposition sent in response to said patient query by said first computing device, said disposition comprising at least one patient instruction, and said disposition not including a diagnosis;
wherein said disposition further comprises provider data input from said third computing device;
wherein said health care provider is within a healthcare network associated with said patient; and
wherein said provider data input is selected from one or more of the list comprising:
patient medical history; regional medical data; and processed data resulting from said patient query at said second computing device.

16. The system of claim 15, further comprising:
a fourth computing device having respective a CPU, data storage, and connection to said wireless network, said fourth computing device associated with a third-party;
said fourth computing device containing third-party medical data; and
wherein said third-party medical data comprises medical data from one or more of: a health insurance provider; a third-party medical database; and a regional hospital.

17. The system of claim 15, further comprising:
said disposition including instructions for a patient visit to said health care provider;
a report generated based upon said patient visit; and
said report sent from said third computing device to said first computing device, whereby said report is stored in said database.

18. The system of claim 15, further comprising:
a diagram presented by said second computing device GUI, said diagram configured to present a plurality of selectable locations on a body;
a list of symptoms based upon each selectable location on said body, said list of symptoms configured to be presented based upon a selection of one of said selectable location; and
said disposition based upon a selected symptom from said list of symptoms.

19. The system of claim 18, further comprising:
at least two selectable images presented on said second computing device GUI, each image being associated with a symptom; and
said disposition based upon a selected image from said at least two selectable images.

20. The system of claim 18, further comprising:
at least two selectable audio samples presented on said second computing device GUI, each audio sample being associated with a symptom;
said second computing device further comprising an audio speaker configured to play said audio samples when selected; and
said disposition based upon a selected audio sample from said at least two selectable audio samples.
